(19) United States
(12) Patent Application Publication
(10) Pub. No.: US 2020/0240558 A1
(43) Pub. Date: Jul. 30, 2020

(54) PASS-THRU WINDOW AND ORIFICE CAP

(71) Applicant: G&G Technologies Inc., Coventry, RI (US)

(72) Inventor: Genko V. Genev, Coventry, RI (US)

(73) Assignee: G&G Technologies Inc., Coventry, RI (US)

(21) Appl. No.: 16/776,430

(22) Filed: Jan. 29, 2020

Related U.S. Application Data
(60) Provisional application No. 62/798,905, filed on Jan. 30, 2019.

(51) Int. Cl. F16L 23/18; F16K 3/02; F16L 41/08

(52) U.S. Cl. CPC F16L 23/18; F16L 41/08; F16K 3/02

(57) ABSTRACT

A sanitary pass-through window with a sanitary ferrule spool assembly including one or two orifice cap or solid cap assemblies to allow the passage of a tube, hose, or cable from an environmentally controlled room to an environmentally different area. The assembly minimizes the transfer of air and particles from one room into another. The assembly can include a seamed or seamless flange on one side of the wall opening for ease of clean-ability, and a solid or split flange clamp on the opposing side for ease of installation. The orifice cap is a subassembly featuring a cap and gate component, which can mate together by locating external bosses on the gate with internal grooves in the cap, and then secure together with a friction fit, spring pin, or other mechanism.

### CROSS-REFERENCE TO RELATED APPLICATION

This application claims benefit to U.S. Provisional Application No. 62/798,905, filed Jan. 30, 2019, entitled “Pass-Thru Window and Orifice Cap,” herein incorporated by reference in its entirety.

### BACKGROUND OF THE INVENTION

A well-known problem in the life sciences manufacturing industry is adhering to the practices essential to consumer product safety and regulatory traceability while developing the most cost-effective manufacturing systems.

This is particularly true in clean room processing environments. In such clean room manufacturing systems, it is common to deliver some type of material, such as a liquid biomaterial, from one type of processing environment area to another type of processing environment area in which the processing of the biomaterials takes place. Typically, this is carried out in separate rooms, each with different environmental requirements, that are separated with a barrier wall. As a result, conduits between processing equipment on the opposing sides pass through the barrier wall, ceiling, or floor. These conduits are commonly in the form of a hose or tube that are passed through orifices in the barrier wall.

This presents the challenge of passing the conduits through the barrier walls while preventing the ingress of hazardous or contaminant material into the clean room through the wall orifice during material processing. In order to accomplish this, the system is constructed to minimize the transfer of air and particles from the clean room (which is typically kept at a positive air pressure but may be kept at negative air pressure) to the outside environment.

There have been attempts to address this problem. For example, a known solution in the prior art is to use a flexible iris valve pass-thru, or a single-use assembly pass-thru configuration. However, these current solutions have drawbacks in clean-ability, adaptability to new manufacturing modes, reusability, and ease of assembly.

### SUMMARY OF THE INVENTION

The present invention addresses and resolves the problems associated with the prior art assemblies and systems. The present invention provides a pass-thru assembly with a simple yet versatile design that can be easily cleaned, easily installed, and easily adapted to new applications and installation environments. With the assembly of the present invention, the end user uses their own hose assemblies, single use or otherwise, thereby eliminating the need for custom single-use assemblies which are disposed of between processing batches while simplifying the assembly process. Moreover, the assembly of the present invention is compatible with industry standard sanitary fittings and eliminates the need for large assemblies of custom components. It can be used in a sanitary, non-sanitary or any other environment or for any purpose.

The instant pass-thru window can, in some embodiments, include a made-to-order sanitary tri-clamp spool, which commonly has a 2″-10″ tube diameter, with a seamless flange at one side of the pass-thru to seal the thru-hole in the wall and a solid or split clamping flange for ease of installation on the opposite side of the wall. The tri-clamp spool is compatible with standard or custom tri-clamp end caps and gaskets for sealing the pass-thru when not in use, and a made-to-order custom orifice cap for use with tubing and cables. Custom made gaskets, caps, and flanges can also be used.

The instant orifice cap can be an assembly that is made of several parts, or sub-assemblies, which when assembled can be compatible with the geometry of a standard tri-clamp end-cap, or other clamp or flange assembly made of at one or more pieces that can be assembled together in different manners. The assembly can consist of a mating “cap” and a “gate” components which snap together once the tubing or cable is placed in the orifice in the “cap.” Once that is done, the “gate” can be mated with the cap via the external bosses on the “gate”, the internal grooves on the “cap” and can be then secured together by a friction fit, spring pin, or other mechanism to positively fix the two components together. Once this is done, the cap can be secured to the standard tri-clamp ferrule on the pass-thru window with a standard or custom gaskets and clamp.

In some embodiments, the orifice cap can be made-to-order for use with any orifice geometry, and can be used with multiple tubes, either through the use of multiple “gate” components, or with two orifices in a single assembly. Any orifice cap can be used on a pass-thru window of the corresponding size, allowing for flexibility in the design of future tubing and cable selections, as all that will be required is a new orifice cap.

The material of construction of the pass-thru assembly of the present invention can be 304 or 316 stainless steel, as needed per the user cleaning requirements determined by the end user but can be constructed using any material. The orifice cap can be machined from stainless steel, and the “gate” can be made from stainless steel, or any non-shedding polymer approved by the end user including Delrin, PTFE, Polypropylene, and others.

### BRIEF DESCRIPTION OF THE DRAWINGS

The novel features that are characteristic of the disclosed Pass-Thru are set forth in the appended claims. However, the preferred embodiments, together with further objects and attendant advantages, will be best understood by reference to the following detailed description taken in connection with the accompanying Figures in which:

FIG. 1A is a perspective view of a first pass-thru assembly according to a first embodiment;

FIG. 1B is a side view of the pass-thru assembly of FIG. 1A disposed in a wall;

FIG. 2 is a perspective view of the pass-thru assembly of FIG. 1A with a spool and flanges;

FIG. 3A is a perspective view of the pass-thru assembly of FIG. 1A with a split flange;

FIG. 3B is a perspective view of the pass-thru assembly of FIG. 1A with a single piece flange;

FIGS. 3C-E show various views of alternative flanges;

FIG. 4A is a front view of a single piece flange;

FIG. 4B is a cross sectional view of the single piece flange of FIG. 4A along the line A-A;

FIG. 4C is a front view of a single piece of a split flange;

FIG. 4D is a side view of the single piece of the split flange of FIG. 4C;

FIGS. 5A-G are various views of the orifice cap according to the first embodiment;

FIGS. 6A-C are various view of an orifice cap according to a second embodiment;

FIGS. 7A & 7B are various view of an orifice cap according to a third embodiment;

FIGS. 8A-8E are various view of an orifice cap according to a fourth embodiment;

FIGS. 9A-9E are various views of various combinations of caps and gaskets;

FIG. 10A shows an installation with two pass-thru assemblies installed side by side with a bifurcated plate;

FIG. 10B shows an installation with a ferrule on a single side of the assembly;

FIGS. 11A & 11B shows an orifice cap assembly with integrated instrumentation;

FIGS. 12A-12C an embodiment of the invention with an iris-type pass-thru configuration; and

FIGS. 13A-13H show a third embodiment of the present invention with a rectangular housing assembly and various actuators.

### DETAILED DESCRIPTION OF THE PREFERRED EMBODIMENT

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like proximal, distal, top, bottom, up, or down are used, they are not intended to limit the systems, devices, and methods disclosed herein. A person skilled in the art will recognize that these terms are merely relative to the system and device being discussed and are not universal.

The present invention generally addresses and resolves the problems associated with the prior art assemblies and systems. The present invention provides a variety of pass-thru assemblies with a simple yet versatile design that can be easily cleaned, easily installed, and easily adapted to new applications and installation environments. With the assemblies of the present invention, the end user uses their own hose assemblies, single use or otherwise, thereby eliminating the need for custom single-use assemblies which are disposed of between processing batches while simplifying the assembly process. Moreover, the assemblies of the present invention are compatible with industry standard sanitary fittings and eliminates the need for large assemblies of custom components. It can be used in a sanitary, non-sanitary or any other environment or for any purpose.

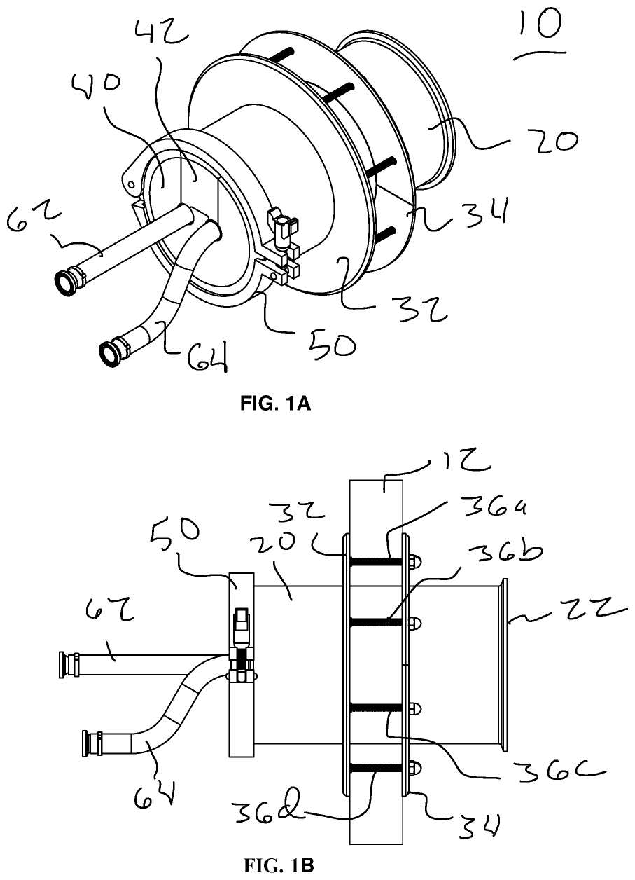

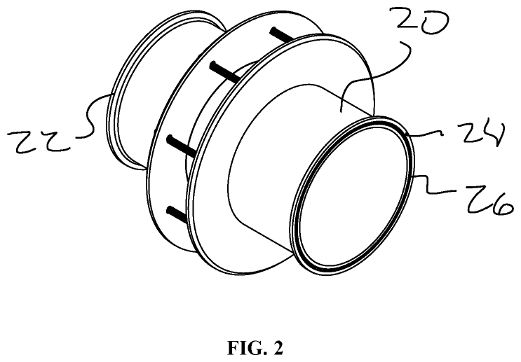

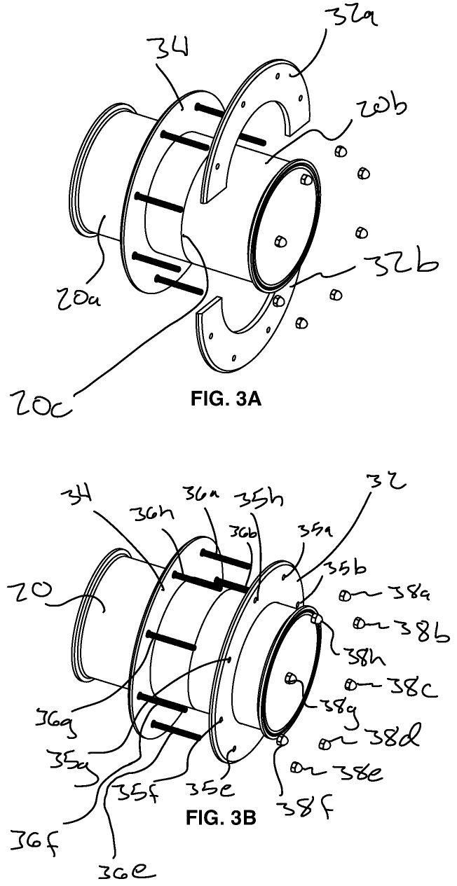

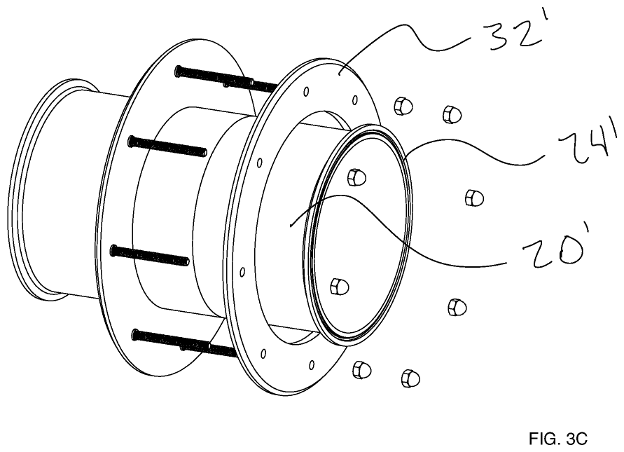

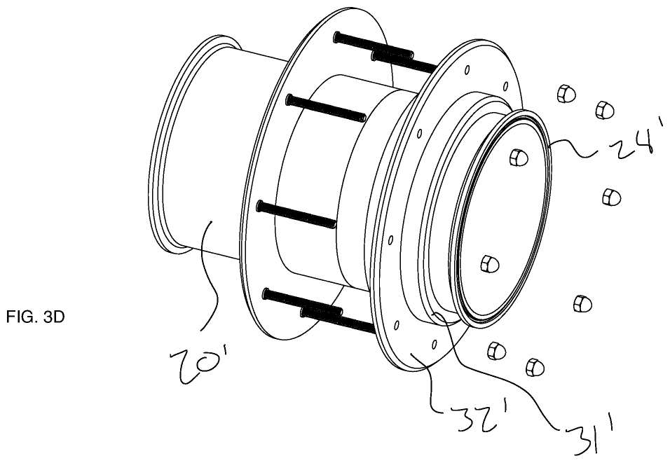

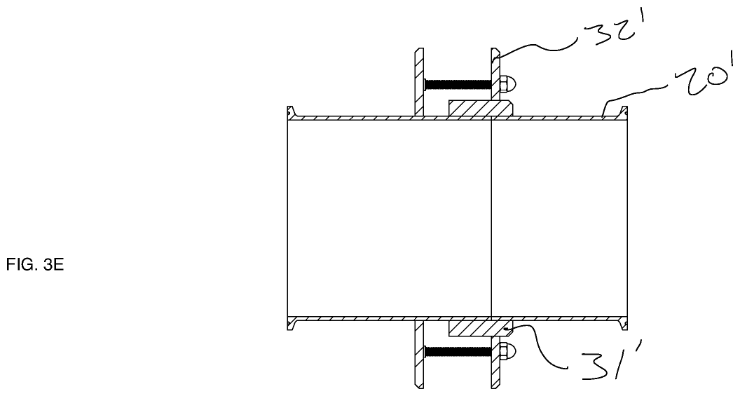

As seen in FIGS. 1-2, in general in a first embodiment, a pass-thru window system 10 is shown that typically includes a made-to-order sanitary tri-clamp spool, with a seamless or seamed flange 32, 34 at one side of the pass-thru to seal the thru-hole in the wall and a solid or split clamping flange for ease of installation located on the other side of the wall. The tri-clamp spools 20 are generally pre-fabricated lengths of tubing with tri-clamp fitting ends 22, 24. The spool 20 can be one or more pieces 20a, 20b, as seen in FIG. 3A, and may be assembled, welded, machined, bolted, or glue in place to form a “single” spool 20 at connection area 20c. The spool 20 can be compatible with standard tri-clamp end caps and gaskets for sealing the pass-thru when not in use, and alternatively can be made-to-order with a custom orifice cap for use with tubing, hoses, cables, and other types of conduits. The present invention can be compatible with the geometry of a standard tri-clamp ferrules and end-caps or other flange assemblies. The assembly 10 can generally include a mating cap component 40 and gate component 42 which can mate together once the tubing or cable/s 62, 64 are placed in the hole(s) of 41a the orifice cap. Once that is done, the gate 42 can be mated with the cap 40 by the external bosses 46a, 46b on the gate and the internal grooves 44a, 44b on the cap and is secured together by a friction fit, or spring pin, or other mechanism to securely fix the two components together. Once this is done, the cap assembly can be secured to a standard tri-clamp ferrule on the pass-thru window with a standard or non-standard gasket and clamp 50. In some embodiments,

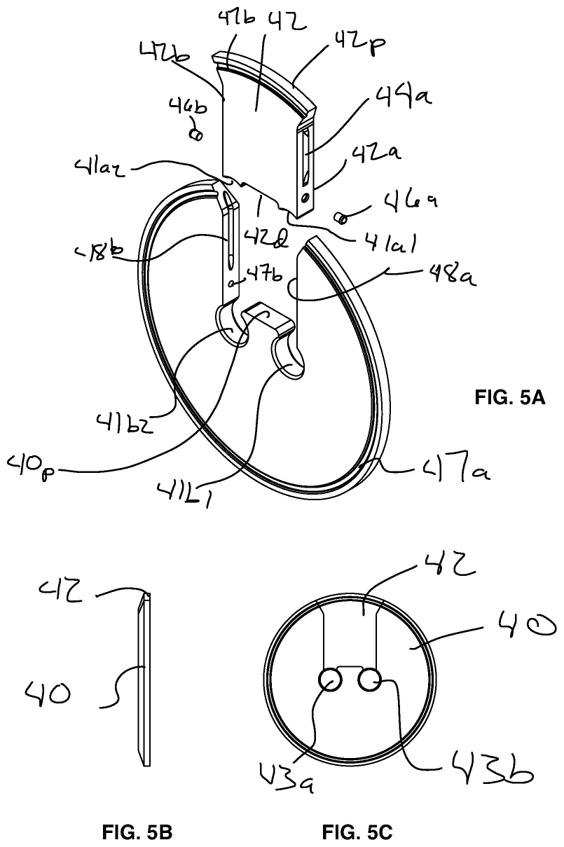

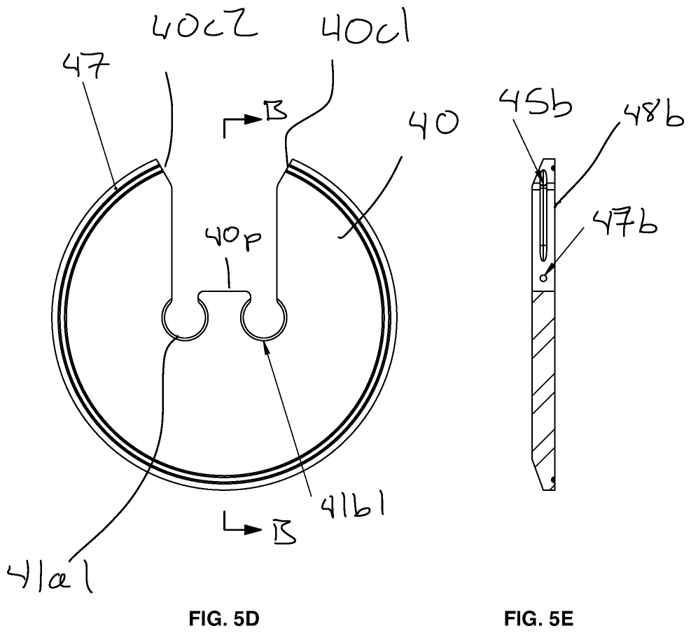

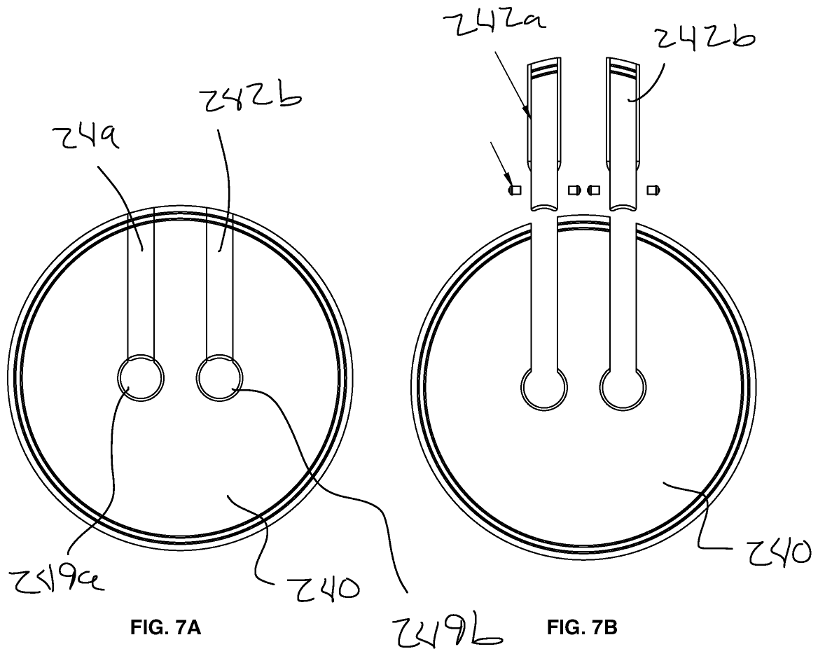

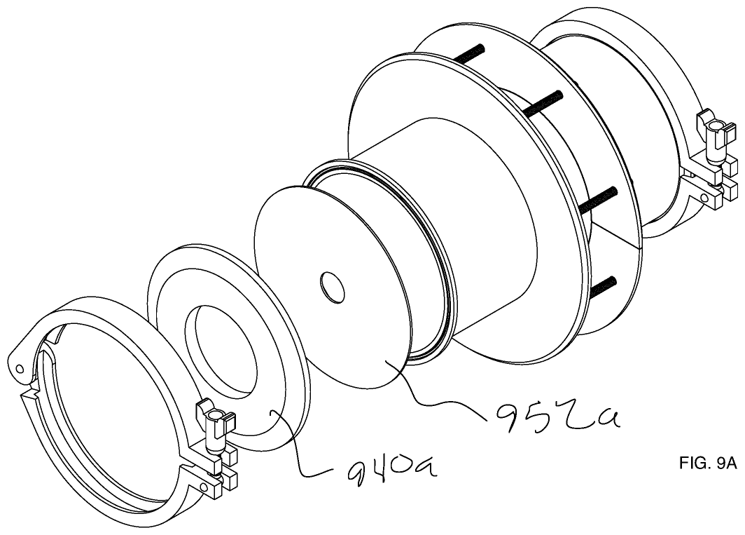

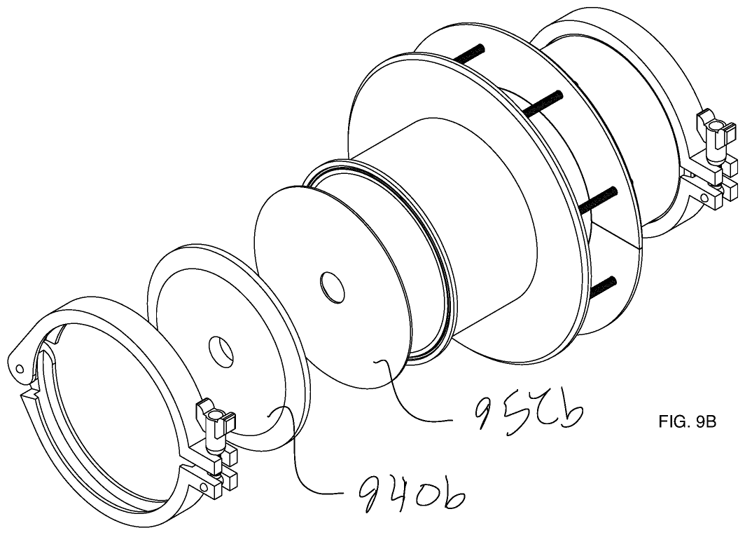

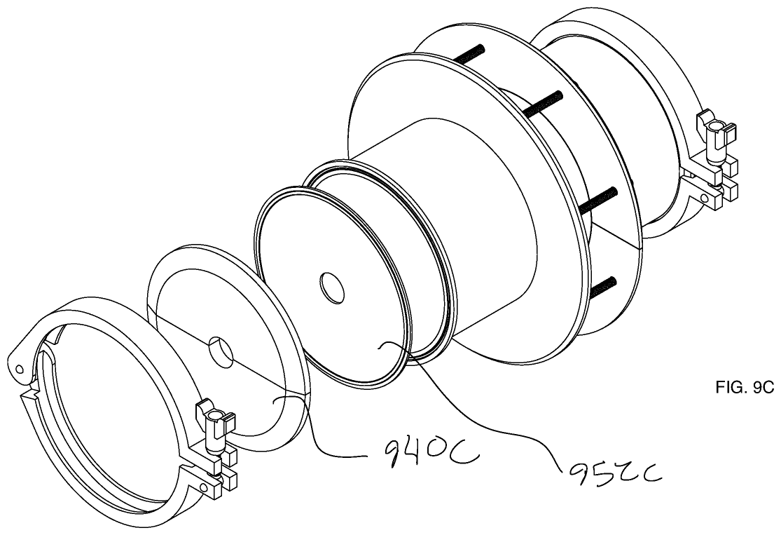

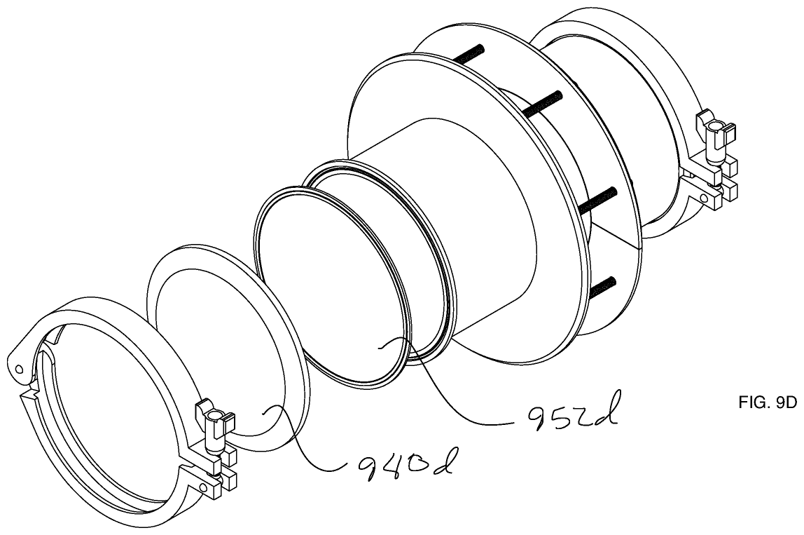

In some embodiments, the orifice cap 40 can be custom made-to-order for use with any tube geometry, and can be used with multiple tubes, as seen in FIG. 1, either with two orifices 43a, 43b in a single assembly, as in FIG. 5A, with a single orifice 143 or through the use of multiple “gate” components 242a, 242b, as in FIGS. 7A & 7B, or an orifice cap with no openings at all, as shown in FIGS. 9D (9E shows standard opening), discussed below. Advantageously, any orifice cap 40 can be used on a pass-thru window of the corresponding size, allowing for flexibility in the design of future tubing and cable selections, as all that will be required is a new orifice cap 40 and/or gasket.

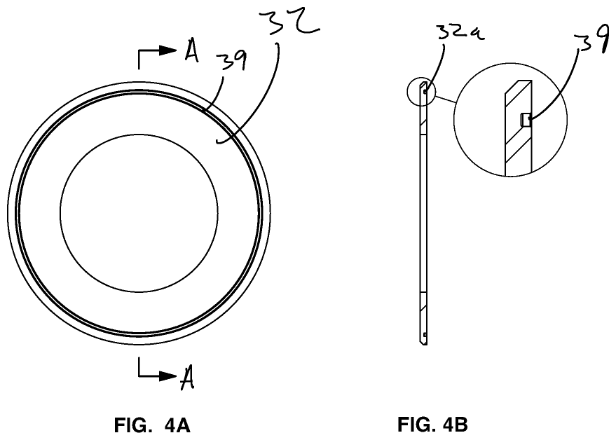

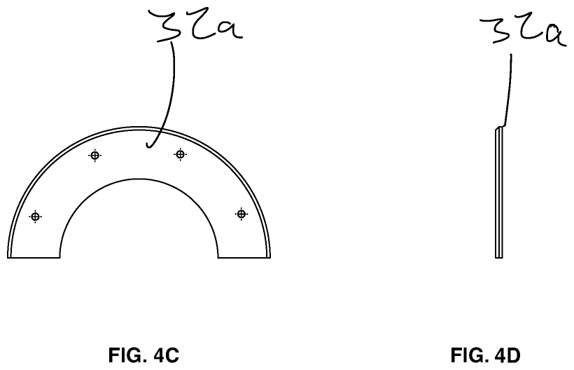

In general, the assembly can include a central pipe, tube, or spool 20 which can be inserted through a hole in a wall 12 between two rooms. For the sake of simplicity, the rooms can both be clean rooms and referred to as a first room and a second room on either side of the wall 12. The spool 20 can have an outer diameter that is generally the same as, or slightly smaller than, a diameter of a hole that is made through the wall 12 to reduce the possibility of material being passed between the rooms. Additionally, a pair of plates, or flanges, 32, 34 can be disposed around the spool 20 on either side of the wall 12 to reduce the passage of contaminates between the two rooms. In some embodiments, the plates 32, 34 can be welded, glued, or screwed, to the spool 20. Each flange 32, 34 can include a plurality of through holes 35a-n for receiving a stud 36a-n to clamp the flanges 32, 34 together against the wall 12. In the illustrated embodiment, eight equally spaced through holes 35a, 35b, 35c, 35d, 35e, 35f, 35g, 35h are shown, however any number of through holes can be used with any desired spacing. The studs 36a-h can have a first, threaded, end and a second, opposite, end of the stud can have a screw head having a diameter that is larger than the through holes on the plates. In the illustrated embodiment, as shown in FIG. 3B, the plurality of studs 36a-h can be welded, or otherwise fixed to a wall facing face of the first flange 34. The flanges 32, 34 can be drawn together by the plurality of studs 36a-h inserted into the plurality of holes 35a-h, respectively, and tightened, by means of a nut or a bolt 38a-h disposed on a respective threaded end of the stud 36a-h and screwed down along the length of the stud. Other securing mechanisms are considered to be within the scope of this invention. The spool, once secured to the wall 12 by means of the flanges 32, 34 and plurality of studs 36a-h and nuts 38a-h can provide for the pass-through between the walls, however because of the open ends it is possible for contaminates to pass through the wall between the two rooms. In some embodiments, a gasket or a seal may be placed between the flange and wall to create an air-tight seal and prevent contamination. In an alternative embodiment, the flanges can be split in two arcs such that the plate is a split plate 32a, 32b, as shown in FIG. 3A, 4C, and 4D. Each of the two arcs can be fit around the spool 20 to create a full circular flange In an additional alternative embodiment, shown in FIG. 4A & 4B, a groove 39 can be disposed circumferentially around a face 32a of the flange that abuts the wall to receive an o-ring (not shown) to seal between the wall and flange in order to prevent contamination.

In some alternative embodiments, as shown in FIGS. 3C-3E, some plates 32′ have an inner diameter that is larger than the outer diameter of the spool 20′ and the outer diameter of the lip 24′. The larger inner diameter of the plate 32′ can accommodate the larger outer diameter of the lip 24′, such that the plate 32′ can be threaded onto the spool 20′. In some embodiments, a sleeve 31′ can be disposed around the spool 20′ but interior to the plate 32′. In some cases, the sleeve 31′ can be welded to the spool 20′ and the plate 32′, or just one or the other, or welded to neither. The plate 32′ can then be assembled as described above.

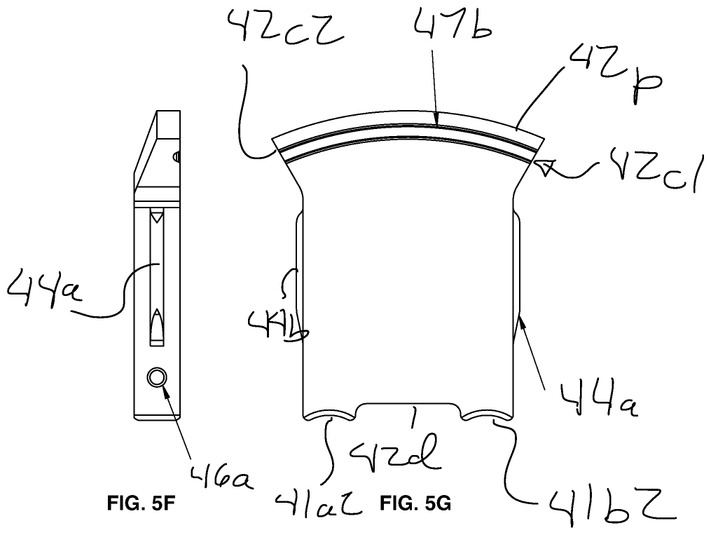

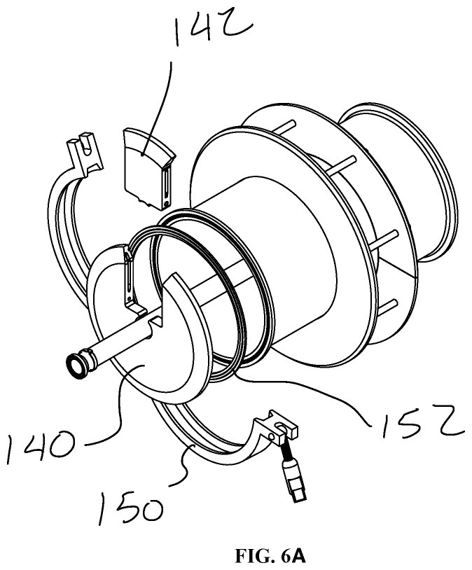

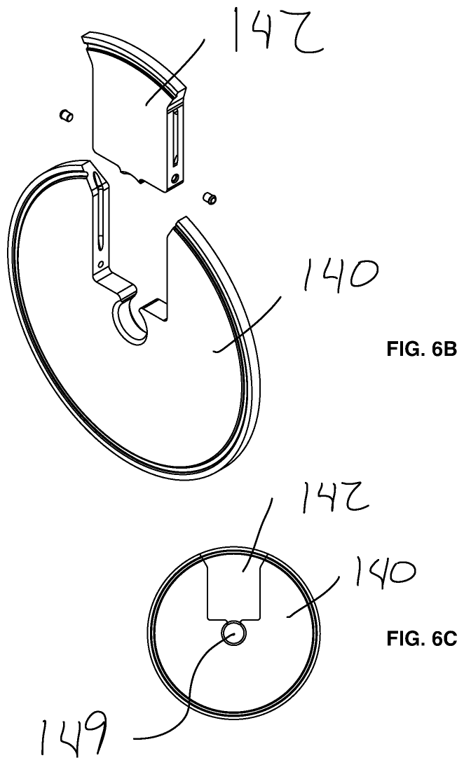

Returning to the spool 20, on either end of the spool a ridge, lip, or tri-clamp fitting ends 22, 24 having a larger outer diameter than the remainder of the spool. The fittings 22, 24 can be used to secure an orifice cap 40 to the spool 20 with a standard or non-standard gasket and clamp 50. As shown in FIG. 1A, the gasket and clamp 50 can be used to surround the fitting 24 of the spool 20 and the orifice cap 40 to secure the orifice cap 40 to the spool 20. The gasket and clamp 50 can advantageously provide for an easy, and non-destructive, means for replacing or re-attaching various orifice caps 40 to the spool. A user may need to remove the orifice cap 40 for the purposes of cleaning or may have new needs which may require different number or sizes of tubing 62, 64. In some exemplary embodiments, as shown in FIG. 6A, an O-ring, 152, may be disposed in a groove on a first side of the orifice cap 140, and against the fitting 124 of the spool 120 to provide for the requisite seal between the two rooms. The groove 47, shown in FIG. 5A, can be disposed on both the body 40 of the orifice cap as groove 47a and the sliding gate 42 portion of the orifice cap 40 as groove 47b.

One of the advantages to the above noted configuration 10, is the ability to easily and non-destructively change out various type of caps 40 and tubing 62, 64 as the needs of the user change. Thus, there is no need for additional holes to be made through the wall 12 to add, or remove, pipes 62, 64 in most circumstances. As such, various orifice caps, like cap 40, will be discussed below.

In the first embodiment, as shown in FIGS. 5A-5G, the combination of the body 40 and sliding gate 42 can be generally circular. The body 40 can have a generally U-shaped opening defined by two vertical surfaces 48a, 48b and a lower, horizontal face 40p. The two vertical surfaces 48a, 48b, which face one another, defining the U-shaped opening can include a locating groove 45a, 45b, seen in the cross sectional view along line B-B in FIG. 5E, disposed axially between the two faces of the body 40. At a radial inward end of the opening, below the grooves 45a, 45b, a respective detent relief hole 47a, 47b can be disposed for receiving a spring pin detent 46a, 46b of the sliding gate 40. At a radially outward facing surface 40p of the opening, at least one or two semi-circular arcs 41a1, 41b1, are provided for receiving the tubing 62, 64 necessary to pass through material from the first room to the second, or vice versa.

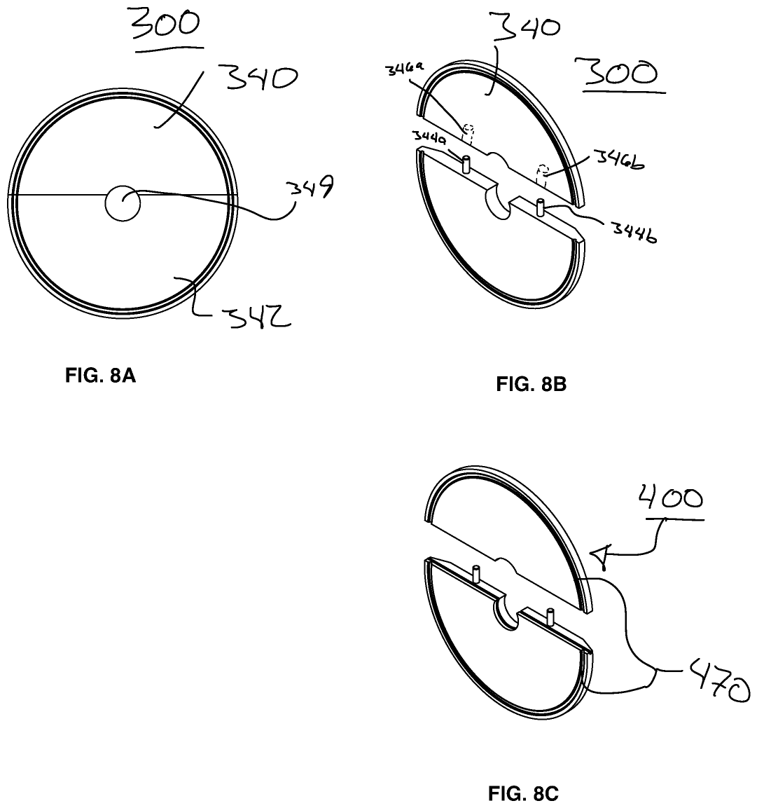

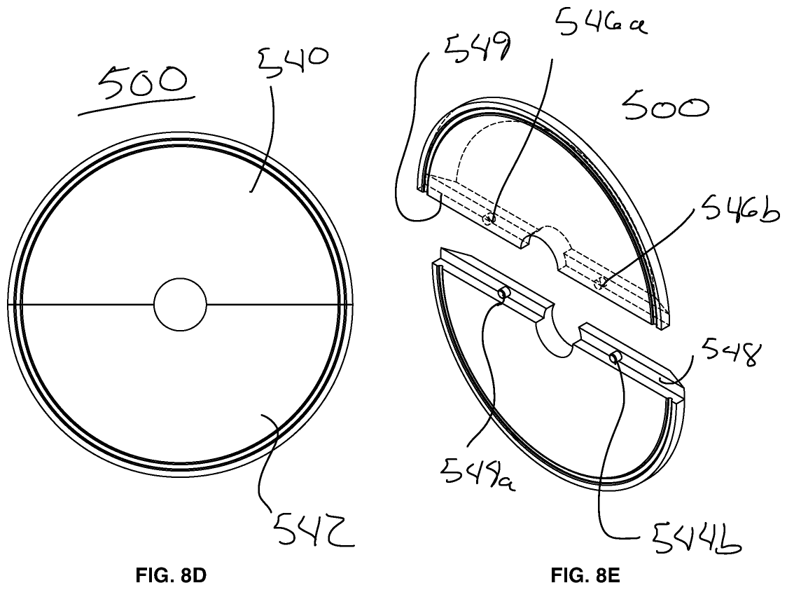

The sliding gate 42 can have corresponding structure which can cooperate with the body 40 to secure the tubing 62, 64 within the cap. For example, the general dimensions of the sliding gate can correspond to the U-shaped opening defined by the two vertical surfaces 48a, 48b and the lower face 40p. On the two side surfaces 42a, 42b of the sliding gate 42 there can be a respective locating tongue, or bosses, 44a, 44b. The respective locating tongues 44a, 44b can be sized and arranged on the sliding gate 42 to be received, or mated, in the locating grooves 45a, 45b to permit the sliding gate 42 to slide relative to the body 40. At the lower ends of the side surfaces 42a, 42b there can be two spring pin detents, or ball nose spring plungers, 46a, 46b which can be received into the relief holes 47a, 47b of the body 40 to lock the sliding gate 42 with respect to the body 40. The sliding gate 42 can be locked to the body 40 by means of friction fit, spring pin, or other mechanisms. On the lower surface 42d of the sliding gate 42 there can be two arced surfaces 41a2, 41b2 which are sized to complete the circumference of the holes created for the tubing 62, 64 and are spaced apart the same distance as the upward facing surface 40p of the body 40. Upper flanges 42c1, 42c2 can extend peripherally outward relative to the side surfaces 42a, 42b and be received against respective inclined surfaces 40c1, 40c2 of the body 40 to prevent the sliding gate 42 from being over inserted within the body 40. In some embodiments, an edge of the orifice cap 40 can be chamfered, or rounded, as shown in at least FIG. 8C.

Once the sliding gate 42 is fully inserted within the body 40, the outer circumference of the orifice cap can be complete and the through holes 43a, 43b can be formed as closed shapes, circles as illustrated. The assembly 10 can be used to secure tubes 62, 64 within the through holes 43a, 43b. The orifice cap 40 can then be disposed against the respective fitting 22, 24 and secured thereto with the standard or non-standard gasket and clamp 50 to the spool 20.

The material of construction of the pass-thru assembly of the present invention can, in some embodiments, be 304 or 316 stainless steel, as needed per the cleaning requirements determined by the end user but can be any material. The orifice cap can be machined from stainless steel, and the gate or other mating can be manufactured from stainless Steel, or any non-shedding polymer approved by the end user including Delrin, PTFE, Polypropylene, and others. In general, the dimensions of the respective pieces can be sized to fit standard parts and tubing required by the end user.

In an alternative embodiment 100, as shown in FIGS. 6A-6C, the assembly 100 can be substantially the same as the assembly 10 of FIG. 1, and only those pertinent differences will be discussed. The differences between assembly 100 and assembly 10 generally relate to the number of pass-through holes on the orifice cap. In the illustrated embodiment of FIGS. 6A-6C, only one through hole 149 is provided. As shown, the sliding gate 142 and the body 140 define a single through hole 149 when the sliding gate 142 is fully inserted into the body. The orifice cap 140 can be secured to the spool 120 by means of the same type of gasket 152 and clamp 150. In other embodiments, three or more through holes can be provided as needed by the end user.

In a further alternative embodiment 200, as shown in FIGS. 7A & 7B, instead of a single gate 42 of the embodiment 10, there can be two, or more, sliding gates 242a, 242b. Each of the two illustrated gates 242a, 242b can be inserted into respective U-shaped openings in the body 240 with the same, or substantially the same, structure of the sliding gates 42, 142 discussed above. In the illustrated embodiment, each of the sliding gates 242a, 242b can define an opening, or through hole, 249a, 249b for a single tube (not shown). In other multiple gate embodiments, one or both of the sliding gates can accommodate a plurality of tubes therethrough.

In some embodiments, as shown in FIGS. 8A-8E, in place of the sliding gate embodiments 10, 100, 200, the orifice caps 300, 400, 500 can be one solid piece or split into two pieces. In the embodiment of FIGS. 8A & 8B, the orifice cap 300 can be split into a first piece 340 and a second piece 342. In the illustrated embodiment, the two pieces 340, 342 are not equal in size, but they can be. In the illustrated embodiment, the second half 342 can have two upward facing pins, or dowels, 344a, b which can be received in respective mating holes 346a, b to align the two parts 340, 342 to define the through hole 349 for a tube (not shown). In the alternative embodiment of FIG. 8C, the orifice cap 400 can be substantially the same as the orifice cap 300 with the addition of a gasket seal 470. In a further alternative embodiment, as shown in FIGS. 8D & 8E, the orifice cap 500 can be split into two pieces 540, 542. The two pieces 540, 542 can each include opposing L-shaped grooves 548, 549. One of the L-shaped grooves 548 can include horizontal, or axially extending, pins 544a, 544b which are arranged to mate with respective mating holes 546a, 546b on the opposing L-shaped groove 549. Each of the respective orifice caps 300, 400, and 500 can be secured to the spools as discussed above.

In other alternative embodiments as shown in FIGS. 9A-9E, various combinations of orifice caps and gaskets can be used. While certain combinations of orifice caps and gaskets are shown, it is understood that any combination of orifice caps and gaskets are within the scope of the disclosure. In certain embodiments, the different combinations of orifice caps and gaskets can provide for better sealing or can serve as back up flanges. For example, in FIG. 9A, a gasket 952a is shown having a through hole having a first diameter that is smaller than the orifice cap 940a that has a through hole having a second diameter. In FIG. 9B, the gasket 952b and the orifice cap 940b can have through holes of the same diameter. In FIG. 9C, a split orifice cap 940c can be used in combination with the gasket 952c. In FIG. 9E, a traditional, standard tri-clamp cap 940d can be used in combination with a standard tri-clamp gasket 952e. In FIG. 9D, a traditional, standard tri-clamp cap 940e can be used in combination with a blank gasket 952d which has no hole. The combinations of gaskets and caps shown in FIGS. 9A-9E can be used with any of the embodiments used herein.

Referring to the above noted embodiments 10, 100, 200, 300, 400, 500 a round housing assembly is provided, which accommodates the passage of hoses, tubing, cables and other from one room to another. The various embodiments 10, 100, 200, 300, 400, 500 can have a port on one side only or both. For example, one could open one side first, make the connections and open the other sided and complete the other connection. Also, one can also open both sides at ones and make the connections. Typically, the clean side is at higher pressure and the pass-through housing could be at higher pressure that the rooms. It should be understood that the configuration may be modified to suit the application at hand to what environment or area needs to be controlled.

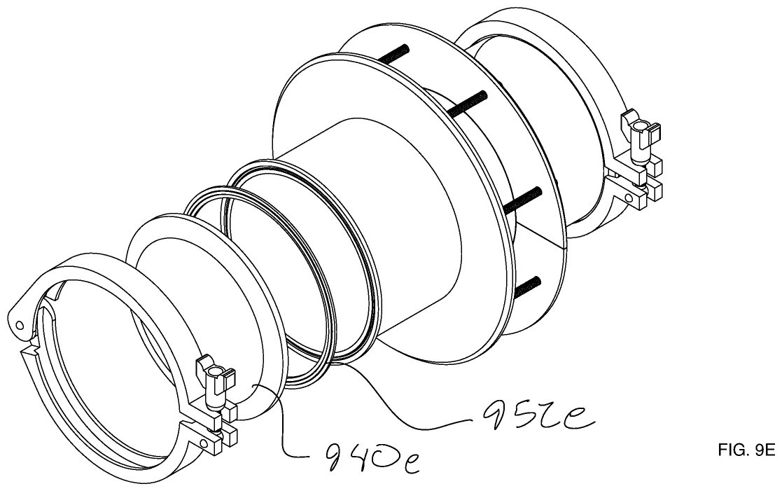

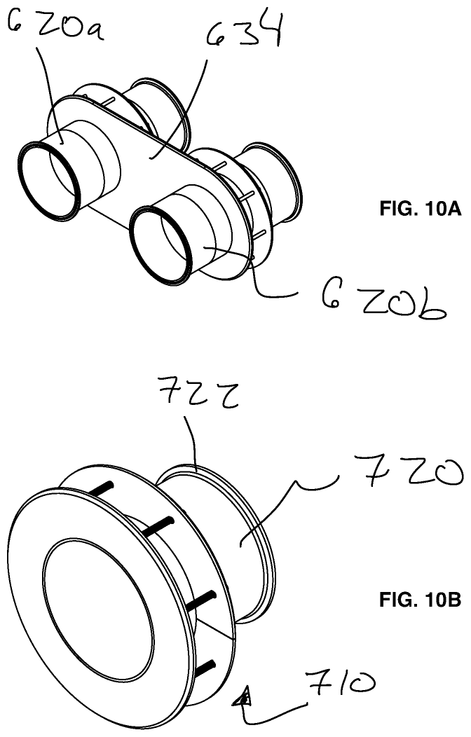

In other alternative embodiments, as shown in FIG. 10A, a flange 634 can be provided with two openings by means of two spools 620a, 620b attached by flange 634 which can be a bifurcated plate. In a further alternative embodiment, as shown in FIG. 10B, a spool 720 can be disposed within a pass-thru 710 such that it only has a connection 722 on a single side. Such an arrangement as shown in FIG. 10B may seal around the conduit which passes through it on one side of the wall only.

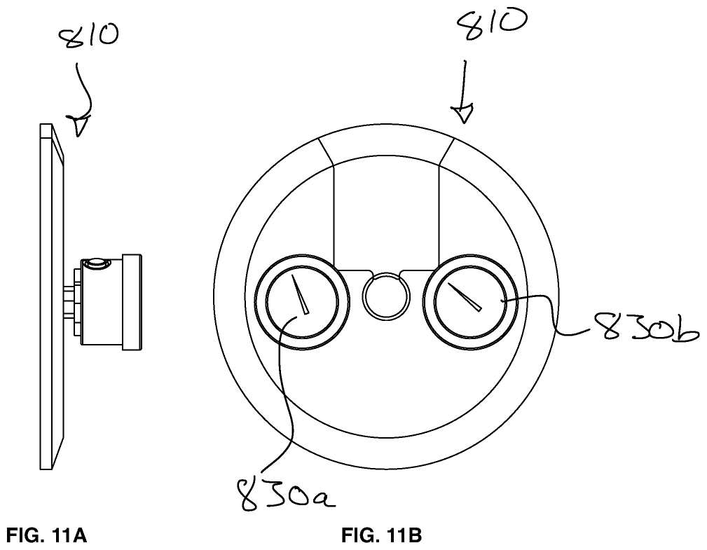

There are a number of possible alternatives within the scope of the present invention. For example, as shown in FIGS. 11A & 11B, the housing 810 can be monitored and controlled with sensors 830a, 830b for air pressure, flow, temperature, and other process parameters. Other accessories such an integrated pinch valve may also be added to this assembly. The sensor 830a, 830b can either mounted on the Pass-Thru Spool Assembly, or on Orifice Caps.

Moreover, the geometry of the Pass-Thrus or any of its components could be any configuration, such as round, rectangular, square, and the like. It may include multiple passageways and the wall thicknesses could vary. One tube could go inside another tube or butt against each other, or other arrangements to create a seal. The seal could be outside the wall or inside the wall. The wall flanges could also have a seal to seal against the wall or the pass-through. The assembly of the present invention could be used for single use components, non-single use or hybrid and can be used to make a sterile or non-sterile connections. Also, it can be used for automated coupling and de-coupling connections between equipment's or components between walls, ceilings or other barriers.

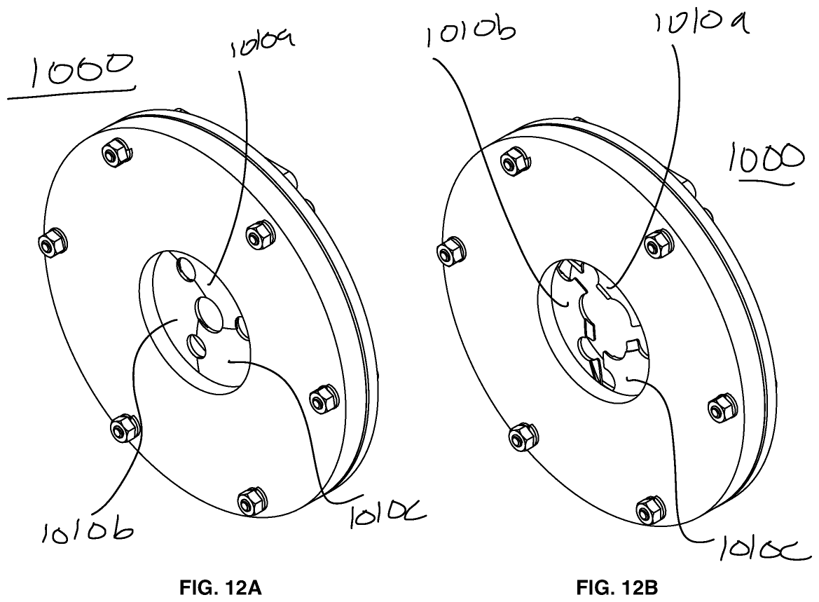

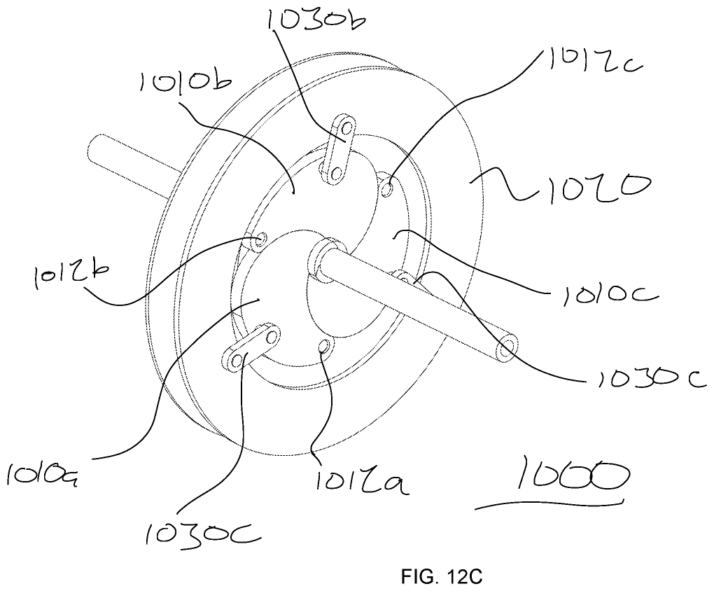

Regarding the iris/shutter assembly configuration 1000 seen in FIGS. 12A & 12B, the same options are available for this embodiment. The assembly 1000 can include one or more movable parts, or shutter elements, 1010a-c may allow the components to pass-through, as needed. The shutter elements 1010a-c may move in unison or independently. For example, as shown in FIG. 12C, the shutter elements 1010a-c can be pivotally attached to an outer ring 1020 at respective pivot points 1012a-c. Each of the shutter elements 1010a-c can be actuated by links 1030a-c. The links 1030a-c may be actuated by means of pulleys, rack and pinions, pneumatics, hydraulics, or electrical actuators. In some embodiments, one of the shutter elements may be stationary or they can all be actuated.

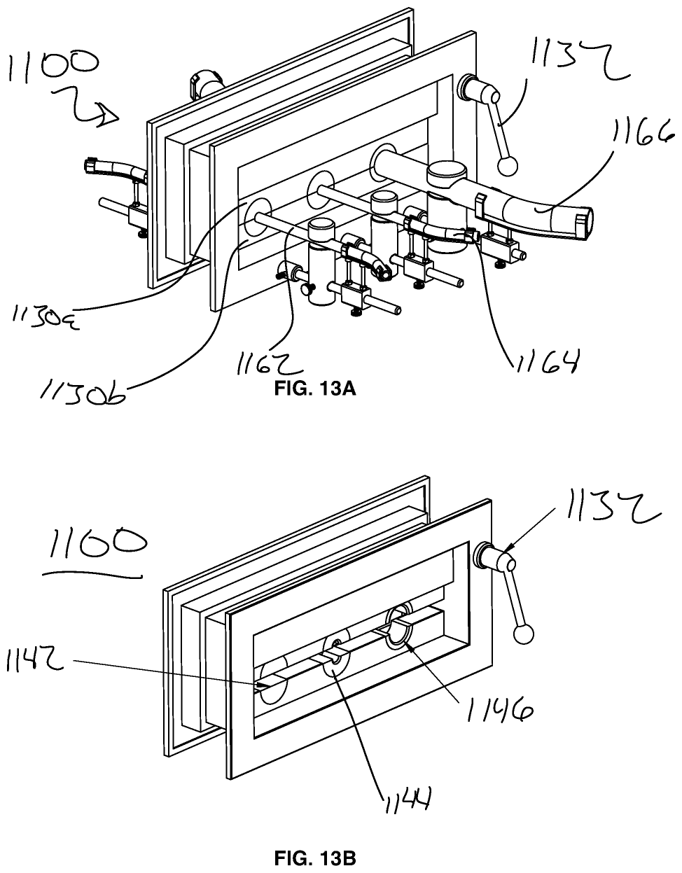

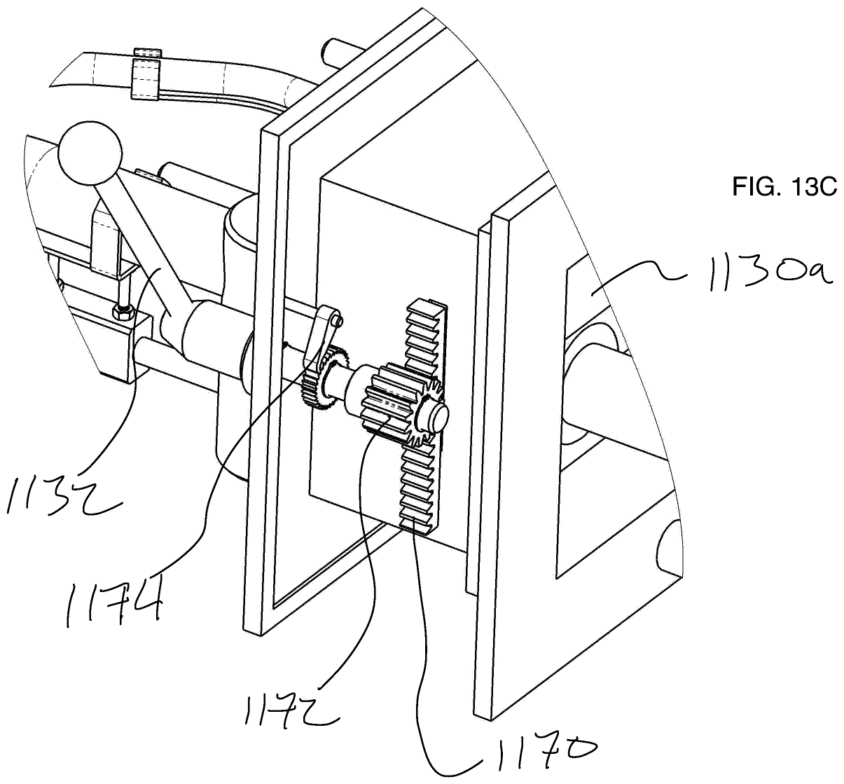

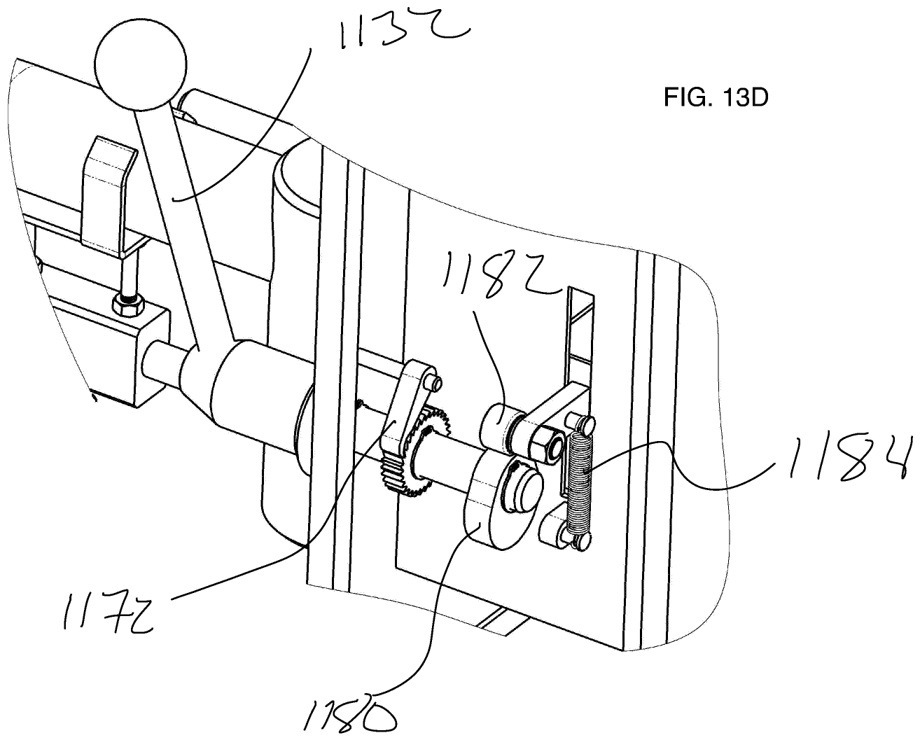

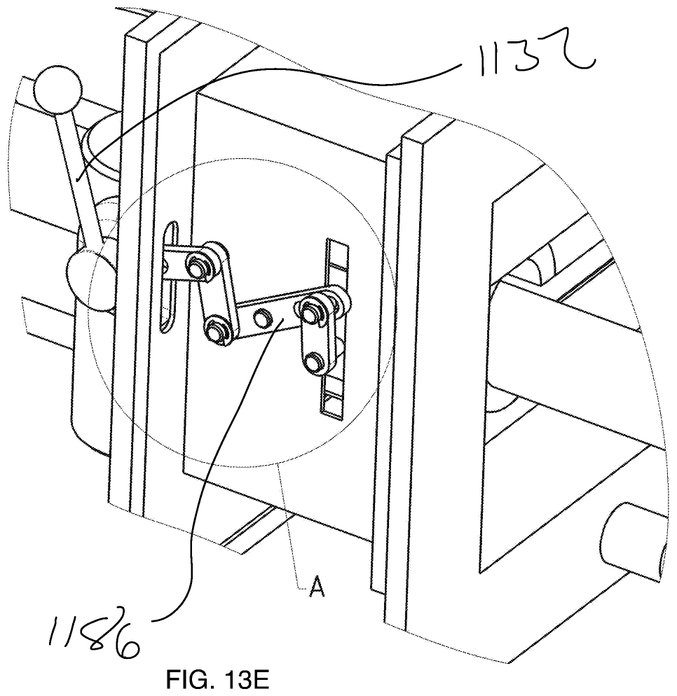

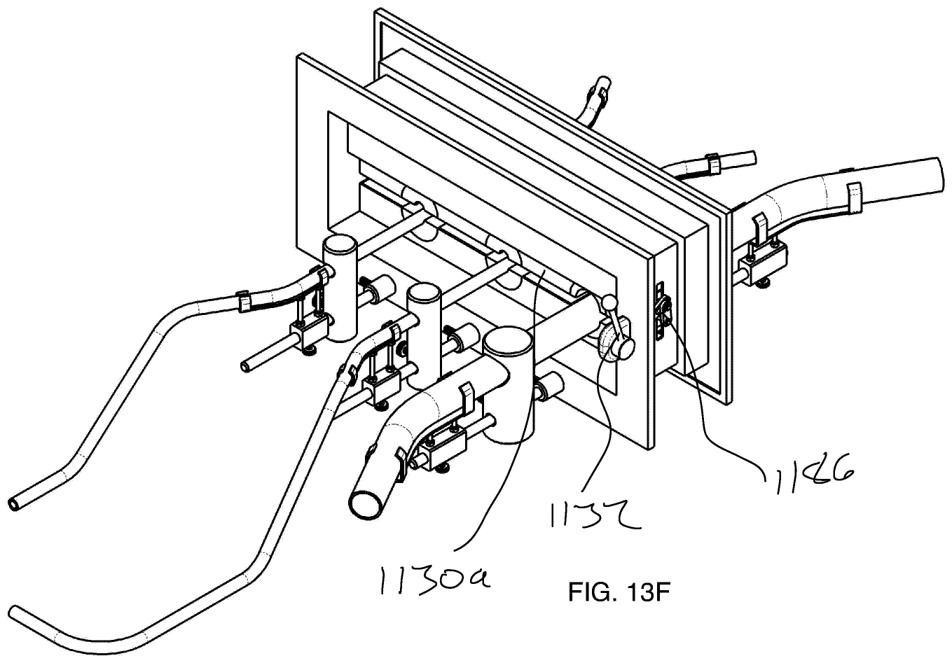

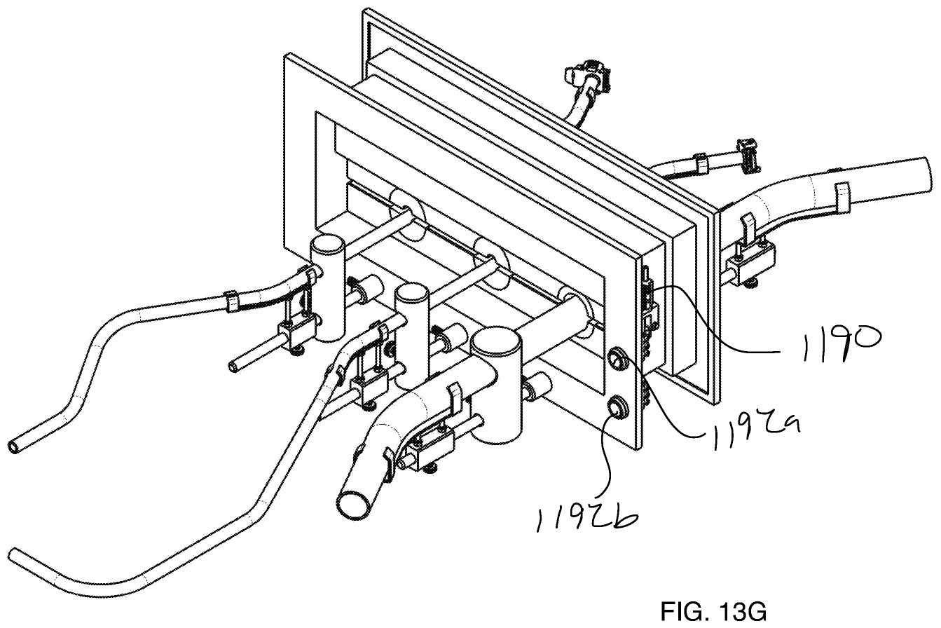

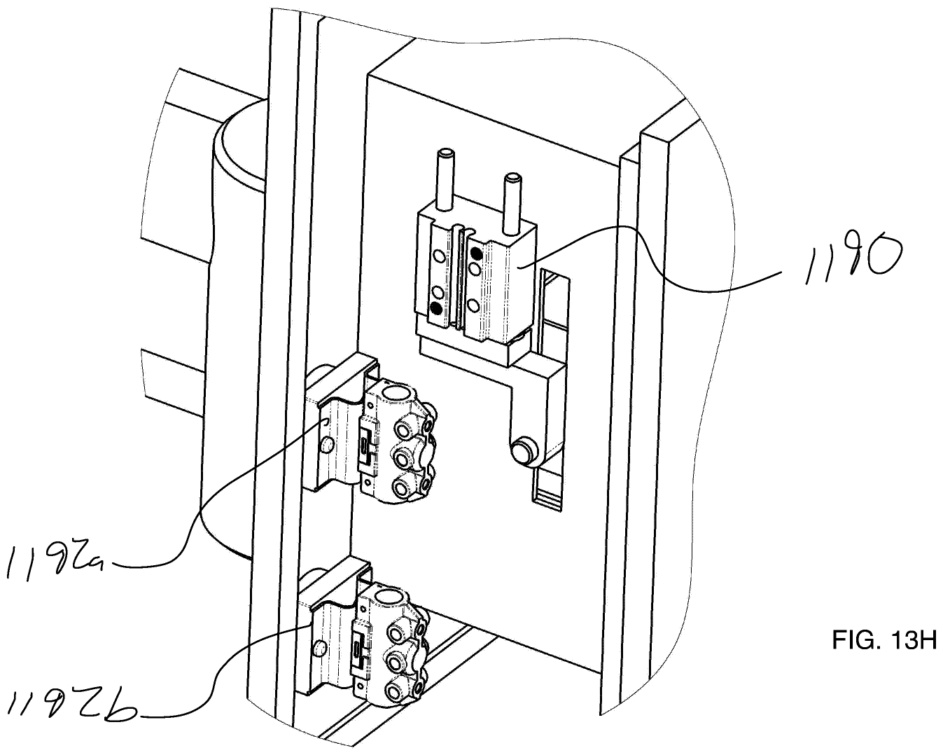

As to the rectangular housing assembly seen in FIGS. 13A & 13B, the same options are available as found with the above embodiments. In this embodiment 1100, orifice caps are not used. Instead, single or multiple actuatable gates 1130a, 1130b can be controlled together or independently from one another so they may receive one or more tubes, cables or other conduit 1162, 1164, 1166 therethrough. One of the gate elements 1130a, 1130b may be stationary or they may both move. The gate elements 1130a, 1130b can be actuated by a lever 1132. The rectangular assembly 1100 can be configured for specific numbers of tube, cables, and the like, with specific sizes to accommodate the application and environment at hand. Further, the system can be design with split arrangement that could be replaced to accommodate different sizes and shapes, for example with the use of replaceable inserts 1142, 1144, 1146 which can be switched or replaced. Plastic, rubber, silicone or other materials inserts 1142, 1144, 1146 could mate with grooves on the panels would allow different sizes of tubes to be used with the design, or to close an opening that is not in use with a solid insert. The actuation may be done by pulleys (not shown). In an alternative embodiment, a rack 1170 and pinion 1172 assembly, as shown in FIG. 13C, can be used to raise one of the gate elements 1130a, b. For example, the rack 1170 can be fixedly connected to gate element 1130a through a window, or opening. The pinion 1172 can be rotated by the lever 1132, and in some embodiments the pinion 1172 can be locked by a pawl 1174.

In another embodiment, as shown in FIG. 13D, the lever 1132 can be used to rotate a cam 1180 which can convert the rotational movement to linear movement of the cam follower 1182 which can be fixedly connected to a gate element 1130a. A spring 1184 can be included to draw the gate element 1130a down when the cam element 1180 is rotated to a downward position.

In a further alternative, as shown in FIGS. 13E & 13F, a linkage 1186 can be used to convert rotational movement of the lever 1132 to raise a gate element 1130a, b. In yet another embodiment, a pneumatic or hydraulic linear actuator 1190 can be used to linearly move a gate element 1130a up or down. In place of a lever, two buttons 1192a, 1192b can be used to activate the linear actuator 1190.

pneumatics, hydraulics, manual actuation, or electrical actuation. Moreover, this gate-type configuration can open vertically, horizontally or any other direction.

As to the caps, the same would apply as already provided. Sensors and other controls may be included and the caps may be modified to accommodate a fit and or seal. Sensors may include pressure sensors, temperature sensors, and flow sensors, which may be standard items or custom made. They may be secured to a cap by a threaded, glued, welded, or clamped connection.

An additional option is envisioned for sealing through the wall, ceiling or other to have at least one device, mechanism, or the like, that could open and close against the component going through. This could be carried out pneumatically, hydraulically, mechanically, electrically, or any other way. This would be similar to an inner tube of a tire where it is deflated to pass-through and the inflated to make the seal.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A pass-thru window and orifice cap assembly, comprising:
a spool;
a mating cap having at least one U-shaped opening including a plurality of grooves and partially defining a through hole;
a gate configured to mate with the mating cap, the gate including bosses thereon; and
a plurality of spring pin detents;
wherein the bosses of the gate are sized and arranged to mate with the respective grooves of the cap,
wherein the spring pin detents are configured and arranged to fix the gate and the mating cap together in a first, mated, configuration, and the through hole is fully defined by the gate and the mating cap,
wherein the cap is be secured to the spool with a gasket and clamp.

2. The assembly of claim 1,
wherein the spool is disposed within a hole in a wall,
wherein one seamed or seamless flange is disposed on a first side of the wall and a second seamed or seamless flange is disposed on a second side of the wall to seal the hole in the wall.

3. The assembly of claim 2,
wherein the one of the first and second flanges includes a plurality of axially extending studs,
wherein the plurality of axially extending studs extend through the wall and the other of the first and second flanges, and
wherein the first and second flanges are drawn together to seal the spool within the wall.

4. The assembly of claim 3, wherein each of the plurality of axially extending studs includes a nut threaded onto the stud against a face of the respective first or second flange through which the stud is inserted.

5. The assembly of claim 1, wherein the mating cap and the gate define a plurality of through holes.

6. The assembly of claim 1, wherein in the first configuration, the mating cap and the gate are mated together to form a circle.

7. The assembly of claim 1, further comprising,
at least one tube inserted within the through hole,
wherein the gate and the mating cap are disposed around the at least one tube creating a seal around the at least one tube.

8. The assembly of claim 1, further comprising
an o-ring or gasket disposed between the mating cap and the spool.

9. The assembly of claim 8, wherein the o-ring is partially disposed within a circumferential groove in the mating cap.

10. The assembly of claim 1, wherein the mating cap and gate are manufactured from stainless steel.

11. The assembly of claim 1, further comprising an additional gate configured to mate with the mating cap and configured to define a second through hole.
